(19) United States
(12) Patent Application Publication
(10) Pub. No.: US 2004/0004541 A1
(43) Pub. Date: Jan. 8, 2004

(54) System for monitoring a dead zone related to a front pillar of a vehicle

(76) Inventor: Jong-Myeon Hong, Seoul (KR)

Correspondence Address: David Tichane, 979 Pinto Palm Terrace, # 24, Sunnyvale, CA, 94087, US

(21) Appl. No.: 10/378,055

(22) Filed: Feb. 28, 2003

(30) Foreign Application Priority Data
Jul. 2, 2002 (KR) 2002-37858

(51) Int. Cl. B60Q 1/00

(52) U.S. Cl. 340/435; 348/148

(57) ABSTRACT

Disclosed is a dead zone monitoring system for monitoring the dead zone of a vehicle. The dead zone monitoring system includes a photographing device disposed on the front pillar for photographing a dead zone of a driver caused by the front pillar of the vehicle; an image controller connected with the photographing device for analyzing, transforming and processing an information image that is photographed by the photographing device; and a display device connected with the image controller by using an imagery signal cable for displaying the information image provided from the image controller. The photographing device can be an optical lens, and the imagery signal cable can be also an optical cable. The display device can be an optical monitor. The dead zone monitoring system can completely monitor the dead zone caused by the front pillar of the vehicle and display an image information on the dead zone just in front of the driver's eyes, so that the driving view field is fully improved security of driving is enhanced.

### CROSS REFERENCE TO RELATED APPLICATION

Applicant claims priority from Korean patent application No. 2002-0037858 filed Jul. 2, 2002.

### BACKGROUND OF THE INVENTION

1. Field of the Invention

The present invention relates to a monitoring system for monitoring a dead zone of a vehicle. More specifically, the invention relates to a monitoring system of a vehicle for monitoring the dead zone related to a front pillar to improve a driving view.

2. Detailed Description of the Related Art

Generally, a vehicle such as an automobile includes a body forming an outer appearance of the vehicle, an engine disposed in the body for generating a power, and a chassis for transmitting the power to a number of power devices and for operating a number of driving devices. The body comprises a floor panel forming a bottom of the vehicle, a frame for reinforcing strength of the body, a plurality of pillars forming side portions of the body, a roof panel formed on the body, and a plurality of doors.

In driving the vehicle, a driver usually gets a front view field through a front window of the vehicle, a rear view field through a rear-view mirror and a side-rear view field through a plurality of side mirrors. Furthermore, the driver can get a side view field through door windows of the vehicle.

However, a front pillar of the vehicle can obstruct the front view field or side-front view field of the driver as shown in FIG. 1.

FIG. 1 is a schematic perspective view of a front pillar of the conventional vehicle. FIG. 2 is a partial sectional view of a dead zone caused by the front pillar as shown in FIG. 1.

Referring to FIGS. 1 to 2, a front pillar 4 of the vehicle, so called an A-pillar, obstructs the front view field of the driver since the front pillar is disposed between front window 1 and a front door window 3. That is, the front pillar 4 can diagonally shut off the driver's view along front-cornered lines, and more particularly, when the vehicle turns to the left, the front pillar 4 inevitably makes a dead zone (commonly referred to as a “blind spot”) along the direction of motion of the vehicle. Therefore, the driver cannot drive carefully and may feel closed in by having the field of view shut off.

However, traffic regulations require an obstructing angle corresponding to a width of the front pillar for the protection of passengers in the event of a vehicle overturn. In addition, the current trend of emphasizing passenger's safety renders a width, a thickness, and a position of the front pillar to be an important element of the vehicle. Namely, the front pillar of the vehicle obstructs the view field of the driver, while simultaneously enhancing passenger safety. Therefore, the front pillar is manufactured so that the front view field and passenger safety in an overturn are simultaneously satisfied.

Disclosed is a plurality of supplementary mirrors adhered to or installed on the vehicle for removing or reducing the dead zone related to the front pillar of the vehicle. However, a supplementary mirror comprising a convex mirror not only distorts distances, but also spoils the appearance of the vehicle. Furthermore, the driver may be confused at image information provided by the supplementary mirror because the supplementary mirror combines information on the dead zone with that beyond the dead zone.

Consequently, a range or magnitude of a dead angle must be accurately measured so as to remove the dead zone caused by the front pillar, to avoid confusing the driver by excess image information, and to improve the front view field of the driver along the direction of motion of the vehicle.

### SUMMARY OF THE INVENTION

The present invention has been made to solve the aforementioned problem, and accordingly it is an object of the present invention to provide a dead zone monitoring system comprising: a photographing device disposed on the front pillar for photographing a dead zone of a driver caused by the front pillar of the vehicle; an image controller connected with the photographing device for analyzing, transforming and processing an information image that is photographed by the photographing device; and a display device connected with the image controller by using an imagery signal cable for displaying the information image provided from the image controller.

According to the present invention, the dead zone caused by the front pillar of the vehicle is completely monitored and displayed to the driver. Simultaneously, the front pillar's dimensions are maintained thus enhancing passenger safety in the event of a vehicle overturn.

### BRIEF DESCRIPTION OF THE DRAWINGS

The above and other objects and advantages of the present invention will become readily apparent by reference to the following detailed description when considered in conjunction with the accompanying drawings wherein:

FIG. 1 is a schematic perspective view of a front pillar of the conventional vehicle;

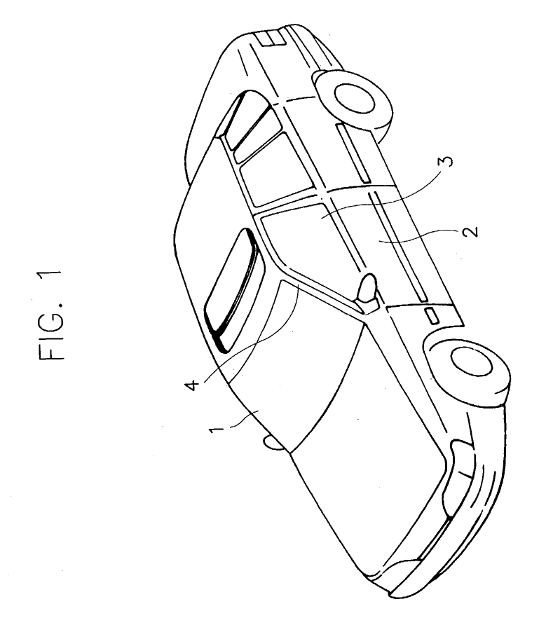

FIG. 2 is a partial sectional view of a dead zone caused by the front pillar as shown in FIG. 1;

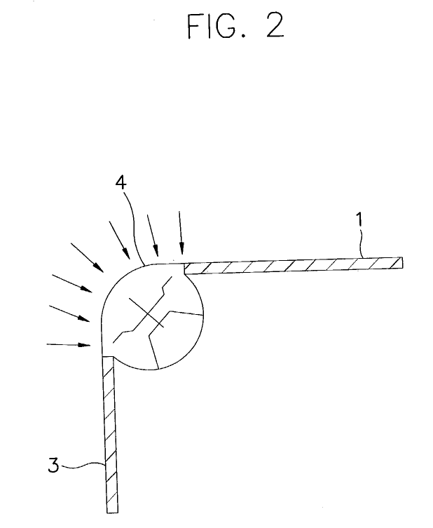

FIG. 3 is a structural view showing a dead zone monitoring system according to a first embodiment of the present invention;

FIG. 4A is a front view showing a guide in which a camera of the monitoring system as shown in FIG. 3 is installed;

FIG. 4B is a front view showing a up-down regulating device on which a display device is installed; and

FIG. 5 is structural view showing a dead zone monitoring system according to a second embodiment of the present invention.

### DETAILED DESCRIPTION OF THE PREFERRED EMBODIMENT

Hereinafter, the present invention will be described in detail with reference to the accompanying drawings.

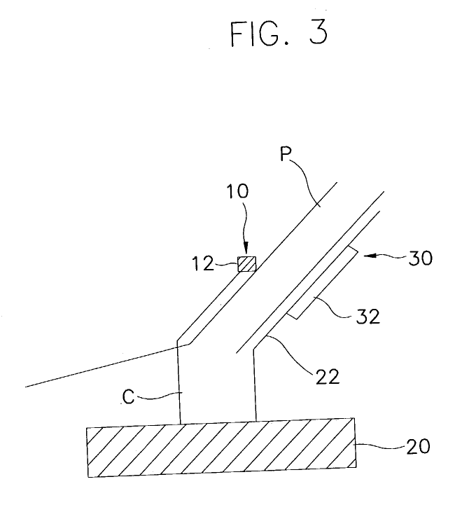

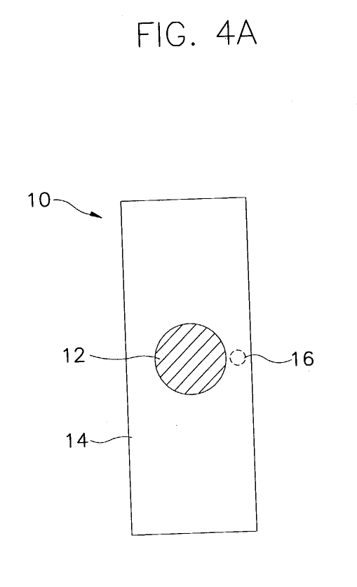

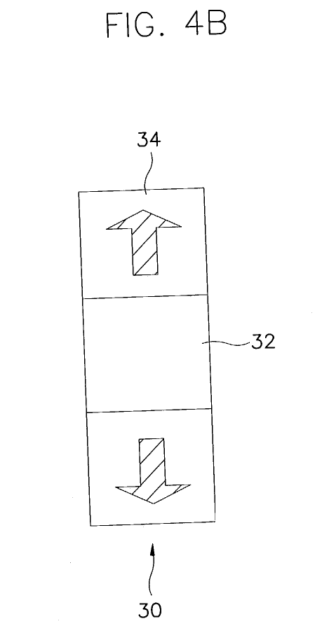

Referring to FIGS. 3, 4A, and 4B, a first embodiment of the dead zone monitoring system caused by a front pillar P of a vehicle includes a photographing device 10, which is disposed outside the front pillar P for photographing driving conditions along front view or side-front view. The photographing device 10 includes a camera 12, and preferably the camera is a subminiature camera. Particularly, the camera 12 is moveably installed to a guide 14 for adjusting a height and a position thereof.

The photographing device 10 is connected with an image controller 20 by using a cable C. The image controller 20 can analyze, transform and process the information image that is photographed by the photographing device and actually shown on a display device successively described.

An image controller is connected with a display device 30 by using an imagery signal cable 22. Though many variations of the display device 30 are known, a monitor 32 is preferred. Particularly, a liquid crystal display device is more preferable to the display device 30. Preferably, the monitor 32 includes an up-down regulator 34 for regulating a position thereof according to a driver's height or position of a driver's seat. Therefore, the monitor can be installed in a position suitable for a respective driver, so that the driver can monitor the dead zone caused by the front pillar with comfort and stability.

The photographing device 10 can selectively include a distance sensor 16. The distance sensor 16 can detect an obstacle in the dead zone and give a warning signal and image information on the obstacle to the driver as well as monitor the dead zone caused by the front pillar P.

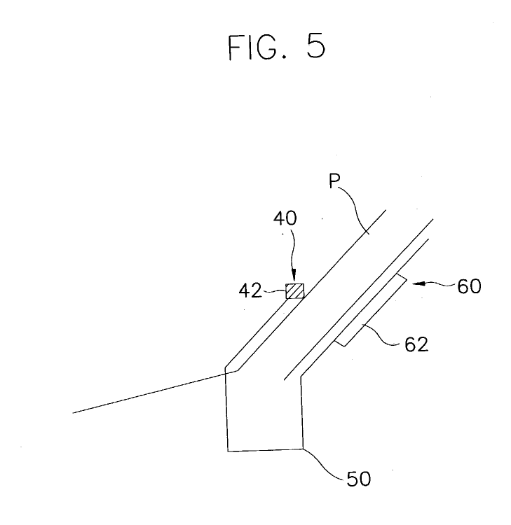

FIG. 5 is structural view showing a dead zone monitoring system according to a second embodiment of the present invention.

Referring to FIG. 5, the second embodiment of the dead zone monitoring system includes a photographing device 40, which is disposed outside the front pillar P for photographing driving conditions along front view or side-front view. The photographing device 40 includes an optical lens 42. An optical cable 50 is connected with the photographing device 40. The optical cable 50 can transmit an image that is photographed through the optical lens 42 and optically condensed. The optical cable 50 is preferably disposed under the vehicle to enhance the outward appearance of the vehicle.

A display device 60 is connected with the optical cable 50. The display device 60 preferably includes an optical monitor 62 which can optically display an image at a height of driver's eye through reverse order of photographing.

The dead zone monitoring system according to an embodiment of the present invention is operated as follows.

At first, the photographing device 10 is installed outside the front pillar P, and a cable C, the image controller 20, and the display device 30 are installed inside the front pillar P. The display device 30 is connected with the photographing device 10 by using the imagery signal cable 22.

The photographing device 10 photographs image information through the camera 12, and the image controller 20 analyzes, transforms, and processes the image information. At last, the image information is displayed on the monitor 32 of the display device 30 through the imagery signal cable 22. Accordingly, the driver can observe the dead zone caused by the front pillar P of the vehicle by using the monitor 32 to thereby carefully and safely drive. At the same time, the display device and the lens can be adjusted to a height suitable for respective drivers of diverse physical attributes.

When the optional distance sensor 16 is installed to the photographing device 10, the distance sensor 16 can detect an obstacle in the dead zone and give warning signal and image information on the obstacle to the driver as well as monitor the dead zone caused by the front pillar P.

Furthermore, when the photographing device 40 disposed outside the front pillar P for photographing driving conditions along front view or side-front view includes the optical lens 42, the photographing device 40 operates in the same way as described in the above passage. As a result, the image information is displayed on the optical monitor 62 of the display device 60 through the optical cable 50.

According to a preferred embodiment of the present invention, the dead zone monitoring system can completely monitor the dead zone caused by the front pillar of the vehicle and display image information on the dead zone just in front of the driver's eyes, so that the driving view field is fully improved and driving security is enhanced. Furthermore, the front pillar can be free from size restriction since the dead zone caused by the front pillar is removed by the monitoring system regardless of the front pillar size. Therefore, the front pillar can be formed not only to have sufficient strength to enhance security of the vehicle but also to give an aesthetic impression.

Although the present invention has been described in detail above, various changes, substitutions and alterations can be made thereto without departing from the true spirit and scope of the invention as defined by the appended claims.

What is claimed is:

1. A dead zone monitoring system for a vehicle comprising:
a photographing device disposed on the front pillar for photographing a dead zone of a driver caused by the front pillar of the vehicle;
an image controller connected with the photographing device for analyzing, transforming and processing an information image that is photographed by the photographing device; and
a display device connected with the image controller by using an imagery signal cable for displaying the information image provided from the image controller.

2. The dead zone monitoring system as claimed in claim 1, wherein the display device includes a monitor, and a regulator for regulating a position of the monitor according to a driver's height or an altitude of a driver's seat.

3. The dead zone monitoring system as claimed in claim 1, wherein the photographing device includes an optical lens, the imagery signal cable is an optical cable, and the display device is an optical monitor.

4. The dead zone monitoring system as in one of claims 1 to 3, wherein the photographing device includes a distance sensor, the distance sensor detecting an obstacle in the dead zone and warning the driver of existence of the obstacle.
